(19) United States
(12) Patent Application Publication
(10) Pub. No.: US 2025/0239722 A1
(43) Pub. Date: Jul. 24, 2025

(54) METHOD FOR FILLING BATTERY PACK WITH EXPANDING FOAM POTTING BY VENTING AIR OUTSIDE OF POTTED REGION

(71) Applicant: GM GLOBAL TECHNOLOGY OPERATIONS LLC, Detroit, MI (US)

(72) Inventors: Anthony Michael COPPOLA, Rochester Hills, MI (US); William Thomas KUCINSKI, Windsor (CA); Mohammad Hamza KIRMANI, Troy, MI (US); Kris KILLEN, Shelby Township, MI (US); Tyler TALASKI, Clarkston, MI (US); Erik Brandon GOLM, Sterling Heights, MI (US); James D. HENDRICKSON, Oxford, MI (US); Sean S. LINCOLN, Berkley, MI (US); Jake ZUCKERMAN, Royal Oak, MI (US)

(21) Appl. No.: 18/421,101

(22) Filed: Jan. 24, 2024

(51) Int. Cl. H01M 50/358; H01M 50/367

(52) U.S. Cl. CPC H01M 50/358; H01M 50/367

(57) ABSTRACT

A battery module includes a housing including a sidewall structure, a top shear plate and a bottom shear plate. A vent tray assembly is disposed within the housing and including a cell tray and a vent tray that combine to define a plurality of vent channels therebetween. The cell tray includes a base plate having a plurality of vent openings in communication with one of the plurality of vent channels. The vent tray assembly includes a plurality of air vents therethrough that are isolated from the plurality of vent channels. A plurality of battery cells each have an end with a vent that is aligned with one of the vent openings in the base plate in the cell tray. A potting foam is dispersed within the housing and between the batteries.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a method for filling a battery pack with expanding foam potting by venting air outside of the potted region.

Cylindrical cell battery packs typically require encapsulating potting material around the cells to provide structural support and thermal runaway propagation protection. Automotive battery packs have utilized a ventilation system that allows individual battery cells to vent through a passage system that isolates the passages from the remaining cells of the battery pack. The vent system must remain open for gas to traverse during a thermal event in order to allow the gas to reach the pack's vent port. Accordingly, during the potting process, the potting needs to be prevented from entering the vent system.

While foam potting is used in several automotive battery packs on the market, voids are common place. Voids can occur as a result of either underfill or entrapped air. The presence of voids may adversely affect thermal runaway performance by allowing migration of inflamed gas between cells or in areas of high voltage, as well as reduce structural performance due to reduced material and uneven distribution. The foam potting is typically composed of a polyurethane, but could also ben an epoxy, silicone, or other resin. Potting is dispensed as a liquid resin then expands due to a chemical reaction. After some time, the material is fully expanded and hardens to form a foam plastic material. During expansion, the foam dispenses air, which must be removed from the battery pack to avoid voids. However, the air vent ports run the risk of allowing foamed resin to pass, which could result in blockages of the vent areas that must remain without potting.

### SUMMARY

According to the principles of the present disclosure, potting is dispensed around the and within the module. Air is pushed towards strategically located vents as the potting expands into foam. The air is pushed into passthroughs from the bottom of the pack and into open cell foam breather strips. Air is allowed to exit the pack by traveling in the open cell foam and in an open channel between the foam.

According to an aspect of the present disclosure, a battery module includes a housing including a sidewall structure, a top shear plate and a bottom shear plate. A vent tray assembly is disposed within the housing and including a cell tray and a vent tray that combine to define a plurality of vent channels therebetween. The cell tray includes a base plate having a plurality of vent openings in communication with one of the plurality of vent channels. The vent tray assembly includes a plurality of air vents therethrough that are isolated from the plurality of vent channels. A plurality of battery cells each have an end with a vent that is aligned with one of the vent openings in the base plate in the cell tray. A potting foam is dispersed within the housing and between the batteries.

According to a further aspect, the cell tray includes a plurality of parallel ribs extending from the base plate of the cell tray and the vent tray includes a base plate and a plurality of parallel ribs that extend from the base plate of the vent tray, and the plurality of parallel ribs of the cell tray and the plurality of parallel ribs of the vent tray combine to form the plurality of vent channels.

According to a further aspect, the air vents are each covered with a semi-permeable media.

According to a further aspect, the plurality of air vents are defined by a plurality of first passthroughs in the cell tray and a plurality of second passthroughs in the vent tray that are aligned with corresponding ones of the plurality of first passthroughs in the cell tray.

According to a further aspect, the plurality of second passthroughs are covered with a semi-permeable media.

According to a further aspect, the plurality of passthroughs in the cell tray each include a protruding portion surrounding the passthrough.

According to a further aspect, the plurality of passthroughs in the vent tray each include a protruding portion surrounding the passthrough.

According to a further aspect, a fitting extends between the plurality of passthroughs in the cell tray and the plurality of passthroughs in the vent tray.

According to a further aspect, the vent tray includes a base plate and a plurality of pairs of parallel ribs that align with a respective one of a plurality of parallel ribs of the cell tray to define the plurality of vent channels.

According to a further aspect, the plurality of air vents are aligned on opposite sides of a breather channel that communicates to an opening that vents to atmosphere.

According to another aspect, a method of making a battery module includes inserting a plurality of battery cells into an upside down housing having a top shear plate and a sidewall structure. Placing a vent tray assembly on top of the batteries, the vent tray assembly including a cell tray and a vent tray that combine to define a plurality of vent channels therebetween, the cell tray including a base plate having a plurality of vent openings in communication with one of the plurality of vent channels, the vent tray assembly including a plurality of air vents therethrough that are isolated from the plurality of vent channels. Dispersing a potting foam into the housing in a pattern that causes the potting foam to reach the plurality of air vents after substantially all of the air within the housing has passed through the air vents.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross-sectional view of a battery pack with venting for a potting region according to the principles of the present disclosure;

FIG. 2 is a cross-sectional view of a gas ventilation tray with venting for a potting region according to the principles of the present disclosure;

FIG. 3 is a schematic view of a battery pack illustrating an example of the potting dispense locations according to the principles of the present disclosure;

FIG. 4 is a cross sectional view of the battery pack showing an example of the potting dispense locations according to the principles of the present disclosure;

FIG. 5 is a schematic view of a battery pack illustrating an air venting system according to the principles of the present disclosure;

FIG. 6 is a schematic view of a battery pack illustrating an alternative air venting system according to the principles of the present disclosure;

FIG. 7 is a schematic view of a battery pack illustrating a further alternative air venting system according to the principles of the present disclosure; and

FIGS. 8A-8H illustrate various air vent passage configurations.

In the drawings, reference numbers may be reused to identify similar and/or identical elements.

### DETAILED DESCRIPTION

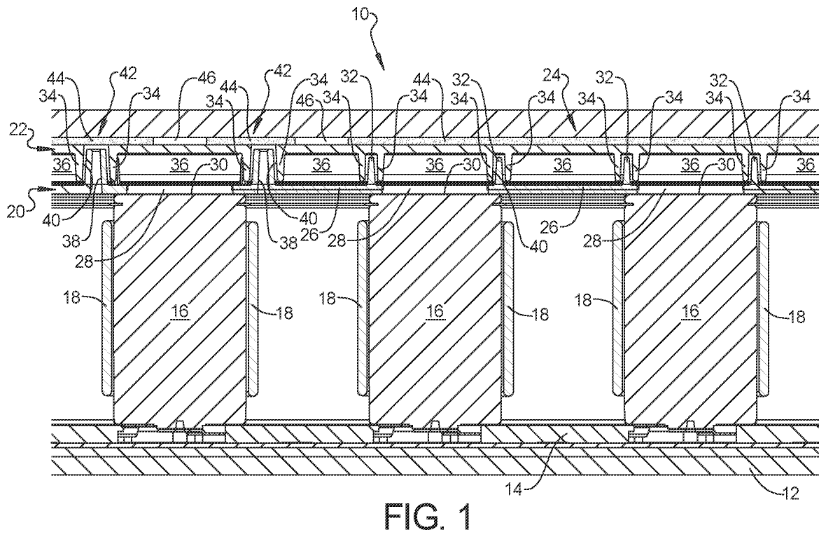

With reference to FIG. 1, a partial cross-sectional view of a battery module 10 is shown in an upside down state relative to its in use position for receiving potting and including an upper shear plate 12 and an integrated circuit board 14. A plurality of battery cells 16 are disposed on top of the integrated circuit board 14. A plurality of cooling ribbons 18 can be disposed between the battery cell rows for cooling the battery cells 16. A cell tray 20 is disposed on top of the battery cells 16 and a vent tray 22 is engaged with the cell tray 20. A bottom shear plate 24 is on top of the vent tray 22.

The cell tray 20 includes a base plate 26 having a plurality of vent openings 28 that align with each of the battery cells 16. A layer of mica 30 can be disposed between the battery cells 16 and the cell tray 20 and covering the vent openings 28. The cell tray 20 further includes a plurality of parallel ribs 32 extending from the base plate 26. The vent tray 22 includes a base plate 33 and a plurality of pairs of parallel ribs 34 that each receive one of the plurality of parallel ribs 32 of the cell tray 20 therebetween. The ribs 32 of the cell tray 20 and the ribs 34 of the vent tray combine 22 to define a plurality of parallel vent channels 36 that align with a plurality of the vent openings 28. The parallel vent channels 36 allow the individual battery cells 16 to vent through the layer of mica 30 and the vent openings 28 while the vent channels 36 isolate the remaining battery cells 16 of the battery pack 10.

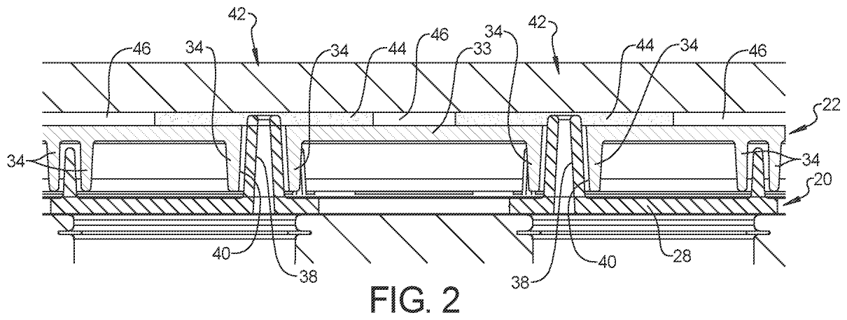

With reference to FIGS. 1 and 2, the cell tray 20 further includes air passthroughs 38 defined within the ribs 32 and aligned with corresponding air passthroughs 40 defined between the pairs of ribs 34 in the vent tray 34. The air passthroughs 38 and 40 of the cell tray 20 and the vent tray 22 combine to define air vents 42. A layer of semi permeable media 44 such as open cell foam, felt, woven or knit fabric, non-woven, paper or other selected membrane is provided overtop of the air vents 42 within a breather channel 46 that is provided between the base plate 33 of the vent tray 22 and the bottom shear plate 24. The air vents 42 are located strategically so that as potting is dispensed around and within the module 10, air is pushed towards the vents as the potting expands into foam. The location of the air vents 42 can be determined based upon testing. The air is pushed into the vents from the bottom of the pack and into the semi-permeable breather strips 44. Air is allowed to exit the pack 10 by traveling in the semi permeable media 44 and the breather channel 46.

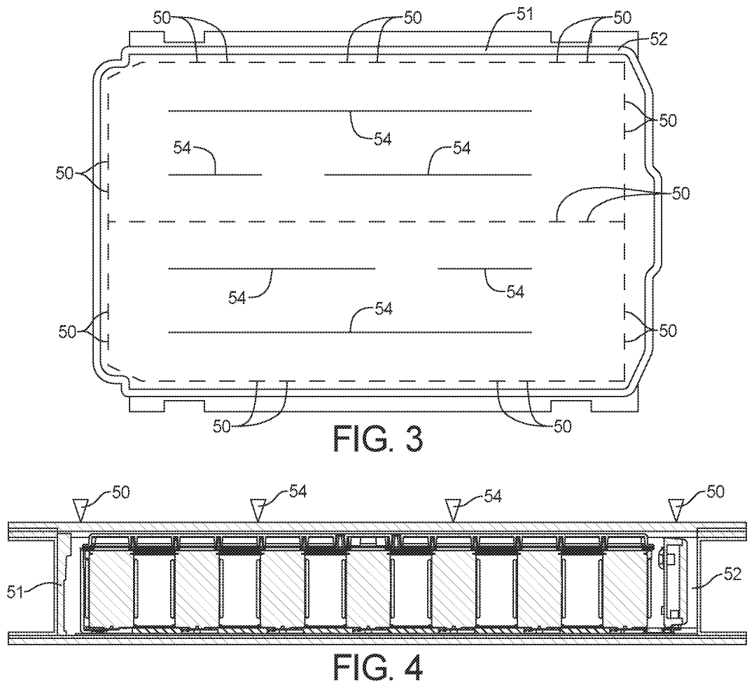

With reference to FIGS. 3 and 4, the battery module 10 is schematically shown with the potting dispense locations illustrated at numerous locations 50 around a perimeter of a sidewall structure 51 and down a center of the housing 52. Additional dispense locations 54 can be provided within an intermediate portion of the housing 52, as shown.

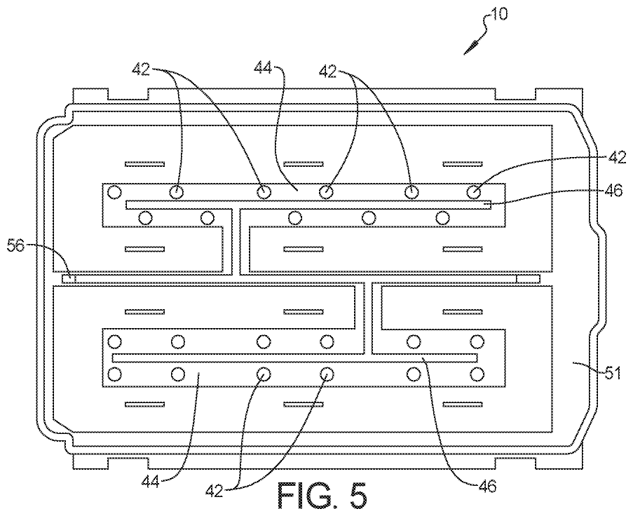

With reference to FIG. 5, the battery module 10 is schematically shown with the air vents 42 located along opposite sides of a breather channel 46. The air vents 42 are covered with the semi-permeable media 44. The air vents 42 can be staggered on opposite sides of the breather channel 46 as shown in the top of FIG. 5, or aligned as shown in the bottom of FIG. 5. The breather channel 46, which does not include the semi-permeable media 44, is connected with an opening 56 that vents to atmosphere.

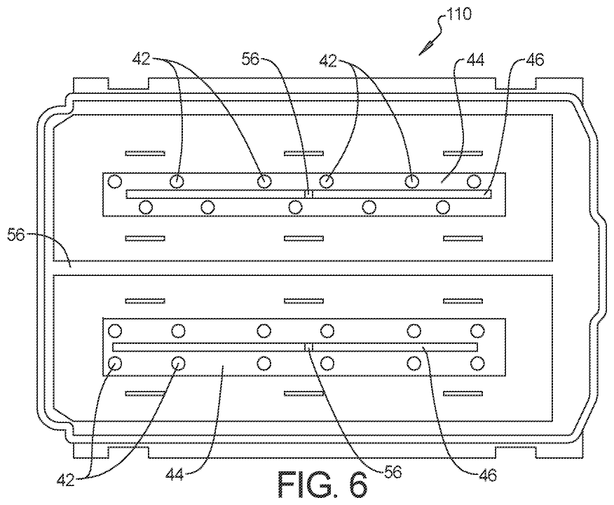

With reference to FIG. 6, an alternative battery module 110 is schematically shown with the air vents 42 located along opposite sides of a pair of breather channels 46. The air vents 42 are covered with the semi-permeable media 44. The two separate breather channels 46 each include their own opening 56 in the vent tray 22 that vents to atmosphere. The air vents 42 can be staggered on opposite sides of the breather channel (top of FIG. 6) or aligned (bottom of FIG. 6).

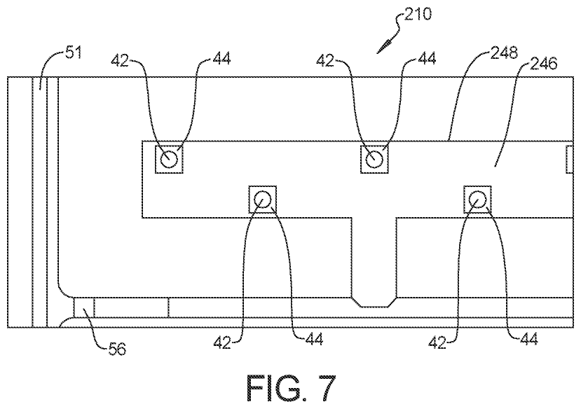

With reference to FIG. 7, an alternative battery module 210 is schematically shown with a plurality of air vents 42 located within a breather channel 246 that is surrounded by a gasket 248 that communicates with an opening 56 that vents to atmosphere. The gasket 248 can be formed from a foam that is dispensed in place. The air vents 42 are covered with the semi-permeable media 44.

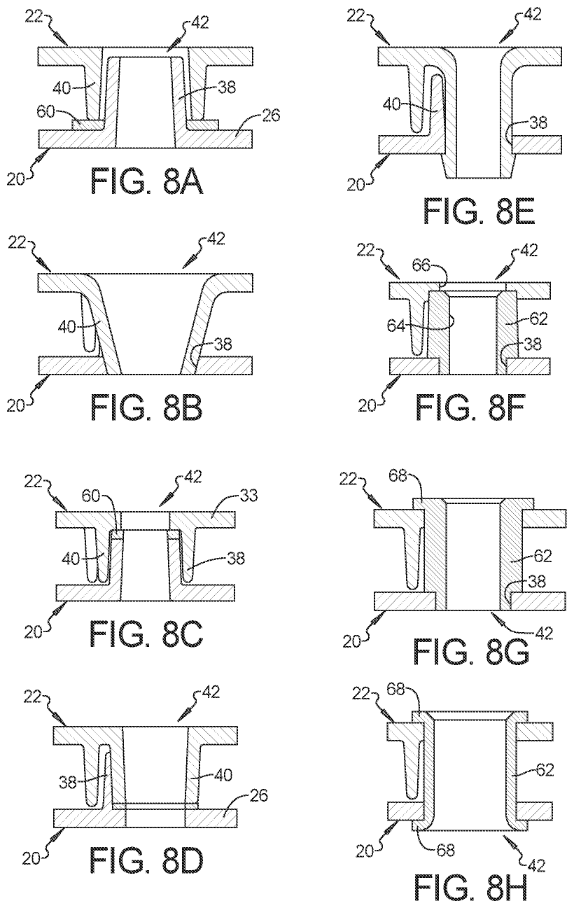

FIGS. 8A-8H illustrate several alternative air vent geometries 42. In FIG. 8A, a cone shaped passthrough 38 that protrudes from the cell tray 20 and is received in a cone shaped passthrough 40 that protrudes from the vent tray 22. A gasket 60 is disposed between the base plate 26 of the cell tray 20 and a distal end of the cone shaped passthrough 40 of the vent tray 22. In FIG. 8B, a passthrough opening 38 is formed in the cell tray 20 and receives a distal end of a cone shaped passthrough 40 that protrudes from the vent tray 22. In FIG. 8C, a cone shaped passthrough 38 protrudes form the cell tray 20 and is received in a cone shaped passthrough 40 that protrudes from the vent tray 22. A gasket 60 is disposed between the base plate 33 of the vent tray 22 and a distal end of the cone shaped passthrough 38 of the cell tray 20. In FIG. 8D, a passthrough opening 38 is formed in the cell tray 20 and a cone shaped passthrough 40 that protrudes from the vent tray 22 buts against the base plate 26 of the cell tray 20. In FIG. 8E, a passthrough opening 38 is formed in the cell tray 20 and receives a distal end of a cylindrical shaped passthrough 40 that protrudes from the vent tray 22 and snaps into the passthrough opening 38. In FIG. 8F, a passthrough opening 38 is formed in the cell tray 20 and receives a cylindrical shaped fitting 62 with a passthrough opening 64 that is aligned with a passthrough opening 66 in the vent tray 22. In FIG. 8G, a passthrough opening 38 is formed in the cell tray 20 and receives a cylindrical shaped fitting 62 with a passthrough opening 64. The fitting 62 is received in a passthrough opening 66 in the vent tray 22. The fitting 62 can include a flange 68 disposed against the vent tray 22. As shown in FIG. 8H, the fitting 62 can include a flange 68 on both ends.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery module, comprising:
a housing including a sidewall structure, a top shear plate and a bottom shear plate;
a vent tray assembly disposed within the housing and including a cell tray and a vent tray that combine to define a plurality of vent channels therebetween, the cell tray including a base plate having a plurality of vent openings in communication with one of the plurality of vent channels, the vent tray assembly including a plurality of air vents therethrough that are isolated from the plurality of vent channels;
a plurality of battery cells each having an end with a vent that is aligned with one of the vent openings in the base plate in the cell tray; and
a potting foam dispersed within the housing and between the batteries.

2. The battery module according to claim 1, wherein the cell tray includes a plurality of parallel ribs extending from the base plate of the cell tray and the vent tray includes a base plate and a plurality of parallel ribs that extend from the base plate of the vent tray, and the plurality of parallel ribs of the cell tray and the plurality of parallel ribs of the vent tray combine to form the plurality of vent channels.

3. The battery module according to claim 1, wherein the air vents are each covered with a semi-permeable media.

4. The battery module according to claim 1, wherein the plurality of air vents are defined by a plurality of first passthroughs in the cell tray and a plurality of second passthroughs in the vent tray that are aligned with corresponding ones of the plurality of first passthroughs in the cell tray.

5. The battery module according to claim 4, wherein the plurality of second passthroughs are covered with a semi-permeable media.

6. The battery module according to claim 4, wherein the plurality of passthroughs in the cell tray each include a protruding portion surrounding the passthrough.

7. The battery module according to claim 4, wherein the plurality of passthroughs in the vent tray each include a protruding portion surrounding the passthrough.

8. The battery module according to claim 4, further comprising a fitting extending between the plurality of passthroughs in the cell tray and the plurality of passthroughs in the vent tray.

9. The battery module according to claim 1, wherein the vent tray includes a base plate and a plurality of pairs of parallel ribs that align with a respective one of a plurality of parallel ribs of the cell tray to define the plurality of vent channels.

10. The battery module according to claim 1, wherein the plurality of air vents are aligned on opposite sides of a breather channel that communicates to an opening that vents to atmosphere.

11. A method of making a battery module, comprising:
inserting a plurality of battery cells into an upside down housing having a top shear plate and a sidewall structure;
placing a vent tray assembly on top of the batteries, the vent tray assembly including a cell tray and a vent tray that combine to define a plurality of vent channels therebetween, the cell tray including a base plate having a plurality of vent openings in communication with one of the plurality of vent channels, the vent tray assembly including a plurality of air vents therethrough that are isolated from the plurality of vent channels;
dispersing a potting foam into the housing in a pattern that causes the potting foam to reach the plurality of air vents after substantially all of the air within the housing has passed through the air vents.

12. The method according to claim 11, wherein the cell tray includes a plurality of parallel ribs extending from the base plate of the cell tray and the vent tray includes a base plate and a plurality of parallel ribs that extend from the base plate of the vent tray, and the plurality of parallel ribs of the cell tray and the plurality of parallel ribs of the vent tray combine to form the plurality of vent channels.

13. The method according to claim 11, wherein the air vents are each covered with a semi-permeable media.

14. The method according to claim 11, wherein the plurality of air vents are defined by a plurality of first passthroughs in the cell tray and a plurality of second passthroughs in the vent tray that are aligned with corresponding ones of the plurality of first passthroughs in the cell tray.

15. The method according to claim 14, wherein the plurality of second passthroughs are covered with a semi-permeable media.

16. The method according to claim 14, wherein the plurality of passthroughs in the cell tray each include a protruding portion surrounding the passthrough.

17. The method according to claim 4, wherein the plurality of passthroughs in the vent tray each include a protruding portion surrounding the passthrough.

18. The method according to claim 14, further comprising a fitting extending between the plurality of passthroughs in the cell tray and the plurality of passthroughs in the vent tray.

19. The method according to claim 11, wherein the vent tray includes a base plate and a plurality of pairs of parallel ribs that align with a respective one of a plurality of parallel ribs of the cell tray to define the plurality of vent channels.

20. The method according to claim 11, wherein the plurality of air vents are aligned on opposite sides of a breather channel that communicate to an opening that vents to atmosphere.
